(19) United States
(12) Patent Application Publication
(10) Pub. No.: US 2020/0122641 A1
(43) Pub. Date: Apr. 23, 2020

(54) MAGIC GLASSES

(71) Applicant: AHMAD ABO ALSHEGHRI, MONTREAL (CA)

(72) Inventor: Ahmad Abo Alsheghri, Montreal (CA)

(21) Appl. No.: 16/658,305

(22) Filed: Oct. 21, 2019

(30) Foreign Application Priority Data
Oct. 22, 2018 (CA) 3021582

(51) Int. Cl. B60R 1/12; H04M 1/02; G02C 11/00; H04N 7/18; G08B 13/196; H04N 7/14

(52) U.S. Cl. CPC B60R 1/12; H04M 1/0264; G02C 11/10; H04N 7/142; H04N 7/181; G08B 13/1966; H04N 7/183

(57) ABSTRACT

Magic Glasses is a glasses equipped with two rear cameras to enable the one who wear it to see the rear view without looking behind.

Since I am wearing glasses and usually human doesn't see behind him unless he looks behind So I found the solution to see behind without looking behind.

My invention is glasses equipped with two rear cameras to enable the one who wear it to see Behind him without looking behind where the upper half of the lenses will show the rear view while he continue to See front view from the bottom part of the lenses. It will be used for all kinds of glasses, medical and sun glasses.

This cameras will be connected by blue tooth and Wi-Fi (internet) to our mobile application in his mobile where he can see the rear view on his mobile. also the glasses will have front cameras and all cameras front and rear can be controlled by the mobile application where he can record what he see front or rear on his mobile application when He wants.

Also and in case he lost the glasses he can find it from our mobile application. He will have a button on the side of the frame to press it when he wants to see rear view and He has this option on the mobile application too.

Also the two rear ends of the frame will have microphone will be connected to our Mobile application by blue tooth or Wi-Fi (internet) where he can answer his phone calls by Clicking on the frame or press the option on the mobile application and he can Listen to music from his mobile.

Also this glasses will show the location of the person who wear it to any person of his choice by having our mobile application on that person mobile for example father and mother can know the location of their kids if the kids are wearing our glasses and also they can see whatever their kids see by enabling the cameras from our application on their mobiles so it will be security tool for the parents where parents and kids will be connected through our application.

Also you can use your glasses to watch your employees or kids by leaving it in suitable place And activate the cameras when you want by using our application while you are outside the company or the home where the glasses will be connected by Wi-Fi to the internet.

For people with eye vision problems we will make a space to install the medical lenses on the frame in front of our glasses TV lenses

The battery will be replaceable or rechargeable and last long time, it will function like CCTV consist of small camera, wires, graphic card and lenses like television or computer screen or new invented screen

“The embodiments of the invention in which an exclusive property or privilege is claimed are defined as follows:”

1. My invention is glasses equipped with two rear cameras to enable the one who wear it to see Behind him without looking behind where the upper half of the lenses will show the rear view while he continue to See front view from the bottom part of the lenses. It will be used for all kinds of glasses, medical and sun glasses.
These cameras will be connected by blue tooth and Wi-Fi (internet) to our mobile application in his mobile where he can see the rear view on his mobile, also the glasses will have front cameras and all cameras front and rear are controlled by the mobile application where he can record what he see front or rear on his mobile application when he wants. In case he lost the glasses he can find it from the mobile application.
He will have a button on the side of the frame to press it when he wants to see rear view and He has this option on the mobile application too.
The two rear ends of the frame will have microphone will be connected to our Mobile application by blue tooth or Wi-Fi (internet) where he can answer his phone calls by Clicking on the frame or press the option on the mobile application and he can lessen to music from his mobile.
this glasses will show the location of the person who wear it to any person of his choice by having our mobile application on that person mobile for example father and mother can know the location of their kids if the kids are wearing our glasses and also they can see whatever their kids see by enabling the cameras from our application on their mobiles so it will be security tool for the parents where parents and kids will be connected through our application.
Also you can use your glasses to watch your employees or kids by leaving it in suitable place And activate the cameras when you want by using our application while you are outside the company or the home where the glasses will be connected by Wi-Fi to the internet.
It will have a battery that last long time.

2. My invention is glasses equipped with two rear cameras to enable the one who wear it to see Behind him without looking behind where the upper half of the lenses will show the rear view while he continue to See front view from the bottom part of the lenses. It will be used for all kinds of glasses, medical and sun glasses.
These cameras will be connected by blue tooth and Wi-Fi (internet) to our mobile application in his mobile where he can see the rear view on his mobile, also the glasses will have front cameras and all cameras front and rear are controlled by the mobile application where he can record what he see front or rear on his mobile application when he wants. In case he lost the glasses he can find it from the mobile application.
He will have a button on the side of the frame to press it when he wants to see rear view and He has this option on the mobile application too.
Also this glasses will show the location of the person who wear it to any person of his choice by having our mobile application on that person mobile for example father and mother can know the location of their kids if the kids are wearing our glasses and also they can see whatever their kids see by enabling the cameras from our application on their mobiles so it will be security tool for the parents where parents and kids will be connected through our application.
Also you can use your glasses to watch your employees or kids by leaving it in suitable place And activate the cameras when you want by using our application while you are outside the company or the home where the glasses will be connected by Wi-Fi to the internet.
It will have a battery that last long time.

3. My invention is glasses equipped with two rear cameras to enable the one who wear it to see Behind him without looking behind where the upper half of the lenses will show the rear view while he continue to See front view from the bottom part of the lenses. It will be used for all kinds of glasses, medical and sun glasses.
These cameras will be connected by blue tooth and Wi-Fi (internet) to our mobile application in his mobile where he can see the rear view on his mobile, also the glasses will have front cameras and all cameras front and rear are controlled by the mobile application where he can record what he see front or rear on his mobile application when he wants. In case he lost the glasses he can find it from the mobile application.
He will have a button on the side of the frame to press it when he wants to see rear view and He has this option on the mobile application too.
The two rear ends of the frame will have microphone will be connected to our Mobile application by blue tooth or Wi-Fi (internet) where he can answer his phone calls by Clicking on the frame or press the option on the mobile application and he can lessen to music from his mobile.
Also you can use your glasses to watch your employees or kids by leaving it in suitable place And activate the cameras when you want by using our application while you are outside the company or the home where the glasses will be connected by Wi-Fi to the internet.
It will have a battery that last long time.

4. My invention is glasses equipped with two rear cameras to enable the one who wear it to see Behind him without looking behind where the upper half of the lenses will show the rear view while he continue to See front view from the bottom part of the lenses. It will be used for all kinds of glasses, medical and sun glasses.
These cameras will be connected by blue tooth and Wi-Fi (internet) to our mobile application in his mobile where he can see the rear view on his mobile, also the glasses will have front cameras and all cameras front and rear are controlled by the mobile application where he can record what he see front or rear on his mobile application when he wants. In case he lost the glasses he can find it from the mobile application.
He will have a button on the side of the frame to press it when he wants to see rear view and He has this option on the mobile application too.
Also this glasses will show the location of the person who wear it to any person of his choice by having our mobile application on that person mobile for example father and mother can know the location of their kids if the kids are wearing our glasses and also they can see whatever their kids see by enabling the cameras from our application on their mobiles so it will be security tool for the parents where parents and kids will be connected through our application.
It will have a battery that last long time.

5. My invention is glasses equipped with two rear cameras to enable the one who wear it to see Behind him without looking behind where the upper half of the lenses will show the rear view while he continue to See front view from the bottom part of the lenses. It will be used for all kinds of glasses, medical and sun glasses.
These cameras will be connected by blue tooth and Wi-Fi (internet) to our mobile application in his mobile where he can see the rear view on his mobile, also the glasses will have front cameras and all cameras front and rear are controlled by the mobile application where he can record what he see front or rear on his mobile application when he wants. In case he lost the glasses he can find it from the mobile application.
He will have a button on the side of the frame to press it when he wants to see rear view and He has this option on the mobile application too.
The two rear ends of the frame will have microphone will be connected to our Mobile application by blue tooth or Wi-Fi (internet) where he can answer his phone calls by Clicking on the frame or press the option on the mobile application and he can lessen to music from his mobile.
It will have a battery that last long time.

6. My invention is glasses equipped with two rear cameras to enable the one who wear it to see Behind him without looking behind where the upper half of the lenses will show the rear view while he continue to See front view from the bottom part of the lenses. It will be used for all kinds of glasses, medical and sun glasses.
These cameras will be connected by blue tooth and Wi-Fi (internet) to our mobile application in his mobile where he can see the rear view on his mobile, also the glasses will have front cameras and all cameras front and rear are controlled by the mobile application where he can record what he see front or rear on his mobile application when he wants. In case he lost the glasses he can find it from the mobile application.
He will have a button on the side of the frame to press it when he wants to see rear view and He has this option on the mobile application too.
It will have a battery that last long time.

7. My invention is glasses equipped with two rear cameras to enable the one who wear it to see Behind him without looking behind where the cameras will be connected by blue tooth and Wi-Fi (internet) to our mobile application in his mobile where he can see the rear view on his mobile Also the glasses will have front cameras and all cameras front and rear can be controlled by the mobile application where he can record what he see front or rear on his mobile application. Also in case he lost the glasses he can find it from our mobile application.
It will be used for all kinds of glasses, medical and sun glasses.
He will have a button on the side of the frame to press it when he wants to see rear view and He has this option on the mobile application too.
Also the two rear ends of the frame will have microphone will be connected to our Mobile application by blue tooth or Wi-Fi (internet) where he can answer his phone calls by Clicking on the frame or press the option on the mobile application and he can lessen to music from his mobile.
Also these glasses will show the location of the person who wears it to any person of his choice by having our mobile application on that person mobile for example father and mother can know the location of their kids if the kids are wearing our glasses and also they can see whatever their kids see by enabling the cameras from our application on their mobiles so it will be security tool For the parents where parents and kids will be connected through our application.
Also he can use his glasses to watch his employees or kids by leaving it in suitable place And activate the cameras when he wants by using our application while he is outside the company or the home where the glasses will be connected by Wi-Fi to the internet.
It will have a battery that last long time.

8. My invention is glasses equipped with two rear cameras to enable the one who wear it to see Behind him without looking behind where the cameras will be connected by blue tooth and Wi-Fi (internet) to our mobile application in his mobile where he can see the rear view on his mobile Also the glasses will have front cameras and all cameras front and rear can be controlled by the mobile application where he can record what he see front or rear on his mobile application. Also in case he lost the glasses he can find it from our mobile application.
It will be used for all kinds of glasses, medical and sun glasses.
He will have a button on the side of the frame to press it when he wants to see rear view and He has this option on the mobile application too.
Also these glasses will show the location of the person who wears it to any person of his choice by having our mobile application on that person mobile for example father and mother can know the location of their kids if the kids are wearing our glasses and also they can see whatever their kids see by enabling the cameras from our application on their mobiles so it will be security tool For the parents where parents and kids will be connected through our application. Also you can use your glasses to watch your employees or kids by leaving it in suitable place And activate the cameras when you want by using our application while you are outside the company or the home where the glasses will be connected by Wi-Fi to the internet.
It will have a battery that last long time.

9. My invention is glasses equipped with two rear cameras to enable the one who wear it to see Behind him without looking behind where the cameras will be connected by blue tooth and Wi-Fi (internet) to our mobile application in his mobile where he can see the rear view on his mobile Also the glasses will have front cameras and all cameras front and rear can be controlled by the mobile application where he can record what he see front or rear on his mobile application. Also in case he lost the glasses he can find it from our mobile application. It will be used for all kinds of glasses, medical and sun glasses.
He will have a button on the side of the frame to press it when he wants to see rear view and He has this option on the mobile application too.
Also this glasses will show the location of the person who wear it to any person of his choice by having our mobile application on that person mobile for example father and mother can know the location of their kids if the kids are wearing our glasses and also they can see whatever their kids see by enabling the cameras from our application on their mobiles so it will be security tool for the parents where parents and kids will be connected through our application.
Also you can use your glasses to watch your employees or kids by leaving it in suitable place And activate the cameras when you want by using our application while you are outside the company or the home where the glasses will be connected by Wi-Fi to the internet.
It will have a battery that last long time.

10. My invention is glasses equipped with two rear cameras to enable the one who wear it to see Behind him without looking behind where the cameras will be connected by blue tooth and Wi-Fi (internet) to our mobile application in his mobile where he can see the rear view on his mobile Also the glasses will have front cameras and all cameras front and rear can be controlled by the mobile application where he can record what he see front or rear on his mobile application. Also in case he lost the glasses he can find it from our mobile application.
It will be used for all kinds of glasses, medical and sun glasses.
He will have a button on the side of the frame to press it when he wants to see rear view and He has this option on the mobile application too.
Also you can use your glasses to watch your employees or kids by leaving it in suitable place And activate the cameras when you want by using our application while you are outside the company or the home where the glasses will be connected by Wi-Fi to the internet.
It will have a battery that last long time.

11. My invention is glasses equipped with two rear cameras to enable the one who wear it to see Behind him without looking behind where the cameras will be connected by blue tooth and Wi-Fi (internet) to our mobile application in his mobile where he can see the rear view on his mobile Also the glasses will have front cameras and all cameras front and rear can be controlled by the mobile application where he can record what he see front or rear on his mobile application. Also in case he lost the glasses he can find it from our mobile application.
It will be used for all kinds of glasses, medical and sun glasses.
He will have a button on the side of the frame to press it when he wants to see rear view and He has this option on the mobile application too.
It will have a battery that last long time.

12. My invention is glasses equipped with two rear cameras to enable the one who wear it to see Behind him without looking behind where the cameras will be connected by blue tooth and Wi-Fi (internet) to our mobile application in his mobile where he can see the rear view on his mobile where he can record what he see on his mobile application, also in case he lost the glasses he can find It using the application. It will be used for all kinds of glasses, medical and sun glasses.
He will have a button on the side of the frame to press it when he wants to see rear view and He has this option on the mobile application too.
It will have a battery that last long time.

13. My invention is glasses equipped with two rear cameras to enable the one who wear it to see Behind him without looking behind where the upper half of the lenses will show the rear view while he continue to See front view from the bottom part of the lenses.
It will be used for all kinds of glasses, medical and sun glasses.
These cameras will be connected by blue tooth and Wi-Fi (internet) to our mobile application in His mobile where he can see the rear view on his mobile where he can record what he sees on His mobile application.
Also and in case he lost the glasses he can find it from our mobile application. He will have a button on the side of the frame to press it when he wants to see rear view and He has this option on the mobile application too.
It will have a battery that last long time.

14. My invention is glasses equipped with two rear cameras to enable the one who wear it to see Behind him without looking behind where the upper half of the lenses will show the rear view while he continue to See front view from the bottom part of the lenses.
It will be used for all kinds of glasses, medical and sun glasses.
He will have a button on the side of the frame to press it when he wants to see rear view.
Also the two rear ends of the frame will have microphone will be connected by blue tooth to his mobile where he can answer his phone calls by Clicking on the frame and he can lessen to music from his mobile. It will have a battery that last long time.

15. My invention is glasses equipped with two rear cameras to enable the one who wear it to see Behind him without looking behind where the upper half of the lenses will show the rear view while he continue to See front view from the bottom part of the lenses.
It will be used for all kinds of glasses, medical and sun glasses.
He will have a button on the side of the frame to press it when he wants to see rear view. It will have a battery that last long time.

16. My invention is glasses equipped with two rear cameras to enable the one who wear it to see Behind him without looking behind where the cameras will be connected by blue tooth and Wi-Fi (internet) to our mobile application in his mobile where he can see the rear view on his mobile Also the glasses will have front cameras and all cameras front and rear can be controlled by the mobile application where he can record what he see front or rear on his mobile application.
It will be used for all kinds of glasses, medical and sun glasses.
He will have a button on the side of the frame to press it when he wants to see rear view and He has this option on the mobile application too.
It will have a battery that last long time.

17. My invention is glasses equipped with two rear cameras to enable the one who wear it to see Behind him without looking behind where the cameras will be connected by blue tooth and Wi-Fi (internet) to our mobile application in his mobile where he can see the rear view on his mobile Also the glasses will have front cameras and all cameras front and rear can be controlled by the mobile application where he can record what he see front or rear on his mobile application. Also in case he lost the glasses he can find it from our mobile application.
It will be used for all kinds of glasses, medical and sun glasses.
He will have a button on the side of the frame to press it when he wants to see rear view and He has this option on the mobile application too.
Also these glasses will show the location of the person who wears it to any person of his choice by having our mobile application on that person mobile for example father and mother can know the location of their kids if the kids are wearing our glasses and also they can see whatever their kids see by enabling the cameras from our application on their mobiles so it will be security tool For the parents where parents and kids will be connected through our application.
Also he can use his glasses to watch his employees or kids by leaving it in suitable place And activate the cameras when he wants by using our application while he is outside the company or the home where the glasses will be connected by Wi-Fi to the internet.
It will have a battery that last long time.

18. My invention is glasses equipped with two rear cameras to enable the one who wear it to see Behind him without looking behind where the cameras will be connected by blue tooth and Wi-Fi (internet) to our mobile application in his mobile where he can see the rear view on his mobile Also the glasses will have front cameras and all cameras front and rear can be controlled by the mobile application where he can record what he see front or rear on his mobile application.
Also in case he lost the glasses he can find it from our mobile application. Also the two rear ends of the frame will have microphone will be connected by blue tooth to his mobile where he can answer his phone calls by Clicking on the frame and he can lessen to music from his mobile.
It will be used for all kinds of glasses, medical and sun glasses.
He will have a button on the side of the frame to press it when he wants to see rear view and He has this option on the mobile application too.
It will have a battery that last long time.

19. My invention is glasses equipped with two rear cameras to enable the one who wear it to see Behind him without looking behind where the cameras will be connected by blue tooth and Wi-Fi (internet) to our mobile application in his mobile where he can see the rear view on his mobile where he can record what he see on his mobile application, also in case he lost the glasses he can find It using the application. It will be used for all kinds of glasses, medical and sun glasses.
Also the two rear ends of the frame will have microphone will be connected by blue tooth to his mobile where he can answer his phone calls by Clicking on the frame and he can lessen to music from his mobile. He will have a button on the side of the frame to press it when he wants to see rear view and He has this option on the mobile application too.
It will have a battery that last long time.

20. My invention is glasses equipped with two rear cameras to enable the one who wear it to see Behind him without looking behind where the upper half of the lenses will show the rear view while he continue to See front view from the bottom part of the lenses. It will be used for all kinds of glasses, medical and sun glasses.
These cameras will be connected by blue tooth and Wi-Fi (internet) to our mobile application in his mobile where he can see the rear view on his mobile, also the glasses will have front cameras and all cameras front and rear are controlled by the mobile application where he can record what he see front or rear on his mobile application when he wants. In case he lost the glasses he can find it from the mobile application.
He will have a button on the side of the frame to press it when he wants to see rear view and He has this option on the mobile application too.
The two rear ends of the frame will have microphone will be connected to our Mobile application by blue tooth or Wi-Fi (internet) where he can answer his phone calls by Clicking on the frame or press the option on the mobile application and he can lessen to music from his mobile.
this glasses will show the location of the person who wear it to any person of his choice by having our mobile application on that person mobile for example father and mother can know the location of their kids if the kids are wearing our glasses and also they can see whatever their kids see by enabling the cameras from our application on their mobiles so it will be security tool for the parents where parents and kids will be connected through our application.
Also you can use your glasses to watch your employees or kids by leaving it in suitable place And activate the cameras when you want by using our application while you are outside the company or the home where the glasses will be connected by Wi-Fi to the internet.
For people with eye vision problems we will make a space to install the medical lenses on the frame in front of our glasses TV lenses
The battery will be replaceable or rechargeable and last long time, it will function like CCTV consist of small camera, wires, graphic card and lenses (like television or computer screen or new invented screen)
